(19) United States
(12) Patent Application Publication
(10) Pub. No.: US 2016/0251104 A1
(43) Pub. Date: Sep. 1, 2016

(54) BOTTLE WITH EXPANSION CHAMBER AND PINCH GRIPS

(71) Applicant: ALPHA CONSOLIDATED HOLDINGS INC., St. Louis, MO (US)

(72) Inventors: James A. Zweifel, Seville, OH (US); John Fortune, Ballwin, MO (US); Danielle Keegan, St. Louis, MO (US); Jay Z. Yuan, Mason, OH (US); Xinzhong Zhang, Mason, OH (US)

(21) Appl. No.: 15/091,452

(22) PCT Filed: Jul. 24, 2014
(86) PCT No.: PCT/US14/47961

§ 371 Date: Apr. 5, 2016

Related U.S. Application Data
(60) Provisional application No. 61/857,768, filed on Jul. 24, 2013.
(60) Provisional application No. 61/879,661, filed on Sep. 18, 2013.

(51) Int. Cl. B65D 1/02; B65D 85/72; B67C 3/28; A47G 19/22

(52) U.S. Cl. CPC B65D 1/023; A47G 19/2205; B65D 1/0207; B65D 1/0246; B65D 1/0276; B65D 85/72; B67C 3/286; B67C 3/284

(57) ABSTRACT

An embodiment of a beverage bottle can have a bottle body defining an interior space configured for storing a beverage. The bottle can include a neck, for example, having an inner neck portion extending from the body. The neck can have an expansion chamber extending beyond the inner portion opposite the body. The neck defines an interior channel in fluid communication with the interior space and extending through the inner portion and expansion chamber to an outlet of the bottle for filling the interior space and pouring the beverage out therefrom. In one embodiment, the interior channel in the inner portion has a first cross-sectional area that leads into the expansion chamber, with the channel in the expansion chamber having a second cross-sectional area that is significantly larger than the first cross-sectional area. This difference in cross-sectional areas can be used to significantly slow the rise of the beverage level in the expansion chamber as the bottle is filled.

### CROSS-REFERENCE TO RELATED APPLICATION

This application claims priority to U.S. Provisional Patent Application No. 61/857,768 entitled “Beer Growler”, filed Jul. 24, 2013, and to U.S. Provisional Patent Application No. 61/879,661, entitled “Bottle With Gussetted Pinch Grips”, filed Sep. 18, 2013, each of which is hereby incorporated by reference in its entirety.

### FIELD OF DISCLOSURE

The present disclosure relates to a bottle with reinforced grips.

### BACKGROUND

Certain issues present themselves during filling of bottles, such as with beverages, some are susceptible to how they are served. Beer, for example, can be negatively impacted during bottling, transportation, and storage depending on the construction of its container. For instance, beer can lose its carbonation over time if carbon dioxide migrates outward through container walls (degassing). At the same time, if oxygen molecules diffuse into the container from the outside, the beer can be oxidized producing off flavors (oxidation). Loss of carbon dioxide and oxidation can likewise affect foam stability. The manner in which it is poured can affect the head achieved in the glass.

When bottling liquids that are under pressure such as in plastic bottles, the pressure tends to force certain features in the bottles to deform. One form of this deformation is for the feature to pop out from its intended shape. Due to the challenges faced with bottling carbonated liquids, bottle manufactures avoid including features such as pinch grips in bottles used for bottling these carbonated liquids.

Due to these properties, beer is typically bottled, transported, and stored in glass or metal bottles. For example, microbreweries typically bottle beer in glass or ceramic growlers for a user to transport draft beer to his or her home for personal consumption. Growlers are typically 64 oz. bottles or jugs and are used for take-out craft beer. Growlers traditionally use a hinged porcelain gasket cap with a heavy duty metal carrying handle that is attached to the glass growler. The ends of the metal handles are securely wrapped around the growler at the neck and body. Some bottles are known that include grip portions for use with still beverages, such as disclosed in U.S. Patent Application Publication Nos. 2011/0049086 and 2008/0083695. However, there is a need for a plastic growler with features for improved handling of carbonated beverages, such as beer. Plastic has been used in small beer bottles that address degassing and oxidation issues, e.g., with the use of gas barrier layers or coatings, oxygen scavenger layers, coatings or capping materials, closure systems, etc. See, e.g., U.S. Patent Application Nos. 2002/0160136; 2003/0042221; and 2013/0126462.

An improved bottle is disclosed with features that can help in filling, transporting, and pouring liquids, such as carbonated or otherwise pressurized fluids or beverages.

### SUMMARY

An embodiment of a beverage bottle can have a bottle body defining an interior space configured for storing a beverage. The bottle can include a neck, for example, having an inner neck portion extending from the body. The neck can have an expansion chamber extending beyond the inner portion opposite the body. The neck defines an interior channel in fluid communication with the interior space and extending through the inner portion and expansion chamber to an outlet of the bottle for filling the interior space and pouring the beverage out therefrom. In one embodiment, the interior channel in the inner portion has a first cross-sectional area that leads into the expansion chamber, with the channel in the expansion chamber having a second cross-sectional area that is significantly larger than the first cross-sectional area. This difference in cross-sectional areas can be used to significantly slow the rise of the beverage level in the expansion chamber as the bottle is filled.

In an embodiment, the second cross-sectional area can be at least about 10% larger than the first cross-sectional area. The second cross-sectional area can be between about 10% to about 75% larger than the first cross-sectional area.

The expansion chamber can have a similar cross-sectional shape as the inner portion. In some configurations, the expansion chamber and inner portion cross-sections can be circular. The inner portion can have a substantially cylindrical portion adjacent the expansion chamber and have the first cross-sectional area.

In an embodiment, the inner portion can have a tapered portion adjacent the expansion chamber that narrows towards the expansion chamber. The first cross-section can be disposed at a transition between the inner portion and the expansion chamber. The expansion chamber can comprise a wall that can be curved in an axial direction with respect to the channel.

The neck portion can be made of a wall having interior and exterior surfaces and the wall can have a generally even thickness such that the interior and exterior surfaces of the expansion chamber have similar shapes. The inner portion can be made of a wall of generally even thickness such that an interior and exterior of the bottle body have similar shapes. The exterior of the expansion chamber can define a finger grip bulge to facilitate carrying the beverage bottle.

The bottle can be made of a plastic material. In an embodiment, the bottle can be made of polyethylene terephthalate.

The bottle can further include a threaded portion through which the interior channel extends and the threaded portion can be configured for attaching to a cap to close off the interior channel. The bottle can contain beer.

In an embodiment, the expansion chamber can be disposed axially along the neck at a capacity level corresponding to the nominal capacity of the bottle to slow the vertical speed of rising beverage during filling as the beverage reaches said capacity level.

The widest portion can be the greatest cross-sectional area of the expansion chamber and the widest portion can be disposed substantially at said capacity level.

In some embodiments, the bottle can be a growler. The bottle can be about 20 to 100 oz. capacity growler.

The body of the bottle can include a shoulder that can be highly tapered towards the inner portion of the neck.

In an embodiment, the body can include opposing pinch grips that can extend radially inwardly with respect to the side wall to facilitate gripping the bottle near a center of gravity thereof. The pinch grips can have pinch walls that define pinch grip indentations in the body and the pinch walls can be angled towards each in an inward radial direction.

In certain embodiments, a bottle may comprise a bottle wall that forms a body with a base. The wall can include an outer circumferential wall which defines an interior space configured for storing a liquid. The wall may have a pinch grip recessed into the body to facilitate gripping the bottle. The pinch grip may include an indentation recessed into the body. The indentation may include a forward wall and a pinch wall. The forward wall and the pinch wall extending inwardly from the outer circumferential wall to the indentation base. The pinch grip may include a gusset extending generally circumferentially across the indentation between the forward wall and pinch wall. The pinch grip may have at least a portion of the gusset extending radially from the base to about 20-80% of the depth of the indentation. The forward walls and the pinch wall meet one another at the indentation base forming an angle to one another. The depth of the indentation is measured radially from the indentation base to the radial height of the circumferential wall adjacent the indentation. At least a portion of the gusset may extend radially from the base by a height above the base of no more than about 60% of the depth of the indentation. The depth of the indentation may be 20%-40% of the radius of the bottle. The gusset may be located axially below half the height of the bottle. The gusset may be located about 30-35% axially above the base of the body. The outer circumferential wall may have a generally even thickness through the pinch grip. In various embodiments, the bottle may be blow molded.

The bottle may also include a second pinch grip located on the bottle at a similar axial height as the first pinch grip to enable pinching between opposed fingers to grip the bottle. The pinch grips may have a circumferential width between the two of 15-25% of the circumference of the bottle at the pinch grip. In various embodiments, the pinch walls may be spaced at an angle to one another of about 2°-30° measured axially about the bottle longitudinal axis.

The bottle may also further include a neck having an inner portion extending from the body. The second pinch grip may be located on the bottle at a similar axial height as the first pinch grip to enable pinching between opposed fingers to grip the bottle. The bottle may have a cap to maintain pressure within the bottle. The bottle may include an expansion chamber extending from the inner portion opposite the body. The neck may define an interior channel in fluid communication with the interior space and extending through the inner portion and expansion chamber to an outlet of the bottle for filling the interior space and pouring a beverage therefrom. The channel in the inner portion may have a first cross-sectional area leading into the expansion chamber. The channel in the expansion chamber may have a second cross-sectional area that is significantly larger than the first cross-sectional area to significantly slow the rise in beverage level in the expansion chamber as the bottle is filled. The second cross-sectional area may be between about 10% to about 70% larger than the first cross-sectional area.

In various embodiments, a method of making a bottle, may include providing a plastic material and blow molding the plastic material to form the bottle variously described above.

A drink container system may include a plastic bottle. The plastic bottle may have a body defining an internal space. The plastic bottle may have opposing pinch grips extending radially inwardly forming a cavities on a circumferential side wall of the body. The pinch grips facilitate gripping the bottle near a center of gravity thereof. A carbonated beverage contained in the body may exert an outward circumferential pressure. A closure sealing the internal space to contain gaseous pressure of the carbonated beverage. A gusset traversing each of the cavities of the pinch grips with the gusset disposed within the cavity and radially below the surface of the circumferential side wall of the body. The pinch grips connect opposing walls of the pinch grip to resist popping out due to the outward pressure from the carbonated beverage. The carbonated beverage may be beer. The plastic bottle may be a growler.

In various embodiments method for bottling a beverage may include providing a bottle. The bottle may include a body having an outer circumferential wall which defines an interior space configured for storing a liquid. The bottle may include a pinch grip recessed into the body to facilitate gripping the bottle, the pinch grip including an indentation recessed into the body. The indentation may have a forward wall and a pinch wall. The forward walls and the pinch wall may extend inwardly from the outer circumferential wall to the indentation base. A gusset may extend generally circumferentially across the indentation between the forward wall and pinch wall with at least a portion of the gusset extending radially from about 20%-80% of the depth of the indentation. The method may also include filling the bottle with a carbonated beverage and capping or otherwise sealing the bottle filled with carbonated beverage to maintain the pressure within the bottle.

A method of filling a bottle to a predetermined nominal capacity can include providing a bottle and filling the beverage into the neck, such that the beverage level has a vertical velocity corresponding to the volume filled into the bottle. The vertical velocity slows significantly at the expansion chamber to facilitate stopping the filling at the nominal capacity. The method can further comprise stopping the filling when the beverage level is within the expansion chamber or slightly above. The beverage can be beer. The bottle can be a growler.

The bottle can also include a threaded portion through which the interior channel extends and the threaded portion can be configured for attaching to a cap to close off the interior channel and the method can further include screwing on the cap to close off the interior channel.

### BRIEF DESCRIPTION OF DRAWINGS

FIG. 1 is a front view of an embodiment of a bottle constructed according to the present disclosure;

FIG. 2 is a cross-sectional view along plane II-II in FIG. 1;

FIG. 3 is an enlarged view of the upper portion of FIG. 1;

FIG. 4 is an enlarged view of the upper portion of FIG. 2;

FIG. 5 is a cross-sectional view of the bottle containing a beverage;

FIG. 6 is an exemplary flowchart illustrating a method of filling the bottle;

FIG. 7 is a back perspective view of another embodiment of a bottle;

FIG. 8 is a back view thereof;

FIG. 9 is a cross-sectional view along plane IX-IX of FIG. 8;

FIG. 10 is a back perspective view of another embodiment of a bottle;

FIG. 11A-C are left, right, and back views thereof;

FIG. 12 is a cross-sectional view along plane XII-XII of FIG. 11A; and

FIG. 13 is a view of a preform being blow molded to form the bottle of FIG. 1 or 7.

### DETAILED DESCRIPTION OF THE EMBODIMENTS

The present disclosure is related to a plastic bottle configured to receive and store beverages, such as carbonated beverage such as beer. Illustrative embodiments will now be described to provide an overall understanding of the disclosed apparatus and processes.

Beer is a fermented alcoholic beverage brewed from malt and often flavored with hops. More particularly, beer is brewed by the saccharification of starch and fermentation of the resulting sugar. The starch and saccharification enzymes are derived from malted cereal grains, most commonly malted barley and malted wheat. Most beer is flavored with hops, which add bitterness and act as a natural preservative, though other flavorings such as herbs or fruit may also be included.

An important aspect of most modern beer is proper carbonation and beer foam. Beer foam is generally comprised of a high molecular weight portion and a low molecular weight portion. The high molecular weight portion is primarily carbohydrate, about 10% of which is protein Z, an albumin with a molecular weight of 40,000 Daltons. The low molecular weight portion is primarily protein, in particular a 9,700 Dalton protein from barley called Lipid Transport Protein 1 (or LTP1).

Low molecular weight portion including LTP1 is generally responsible for forming beer foam, while the high molecular weight portion including protein Z may aid in stabilizing beer foam. More particularly, LTP1 is hydrophobic. During the process of brewing beer, LTP1 is denaturalized and loses its three dimensional conformation. As such, in its denatured form, it is driven to avoid water and complex with carbon dioxide, a byproduct of barley fermentation, thereby forming the bubbles of beer foam.

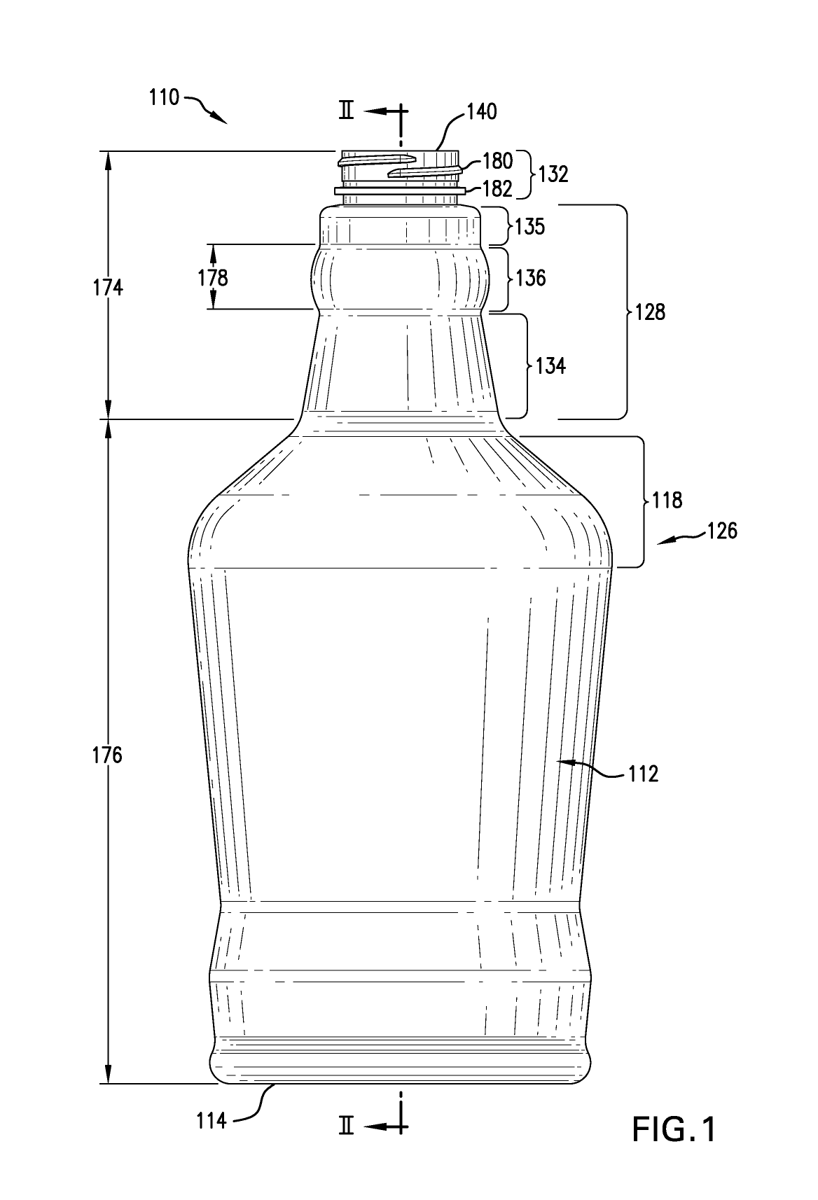

Referring to FIG. 1, bottle 110, which can be configured as a growler, is preferably formed from a plastic, although some embodiments of the growler are made of glass or ceramic or other suitable materials. One plastic embodiment is made of a polymer specifically designed for on-site, on-demand bottling of a beverage, such as beer. The bottle 110 is preferably optimized for short-term storage, ease of pour, and/or proper maintenance of foam upon pour. In the craft brewing industry, where the bottles 110 are filled with beer on-site, directly from the tap, and intended to be consumed within days (e.g., 1-2 days) of filling and are kept refrigerated during that period, degassing and oxidation of the beer are of less importance than in typical beers, which are intended to be able to be stored for extended periods, and often at room temperature or higher. Consequently, some embodiments meant for craft and other microbrewers can be made of a monolayer plastic, such as a mono-layer virgin polymer without oxygen scavenging layers, for instance. Alternative embodiments, however, can be made with such additional layers or of other materials.

Plastic bottle embodiments are preferably formed from of a food-grade polymer, such as virgin or recycled (such as post-consumer regrind) polyethylene terepthalate (PET), which may be provided as a mono-layer, or alternatively multilayer, and can be a food-grad resin such as when used for beer or other beverages. PET may be used for forming bottles for carbonated beverages because it provides good barrier properties to alcohol and essential oils, generally good chemical resistance, and a high degree of impact resistance and tensile strength. Other suitable polymers may alternatively or additionally be used, for example in virgin or food-grade-recycled form, such as polyethylene naphthalate (PEN), polyvinyl chloride (PVC), high density polyethylene (HDPE), or low density polyethylene (LDPE), or other plastic resins. Alternatively, the suitable polymer is not required to be a virgin polymer. In the preferred embodiment, the bottle 110 is made of a recyclable material.

Preferably, the bottle 110 is made from an opaque or semi-opaque material to reduce the amount of light exposure of the beverage therein. With respect to beer, when beer is exposed to light the hop-derived molecules, such as isohumulones (also known as isomerized alpha acids), breaks down into free radicals that react with sulfur-containing proteins to make 3-methyl-2-butene-1-thiol. This chemical produces an unpleasant odor and taste in the beer. In some configurations, the bottle 110 is substantially made from an opaque material but for a portion of the expansion to allow a person to view the volume level of the beverage during filling. As the bottle 110 may contain a variety of beverages, some may be sensitive to light as discussed above with beer and other may not be sensitive to light. Furthermore, in certain application even beverages that are sensitive to light may non-the-less benefit from a container that is made from a material that is not opaque or semi-opaque. As such, in accordance with other embodiments, the bottle 110 may be translucent, clear, substantially clear, or any material with a tint of or solid color.

In an embodiment, the bottle 110 is at least about 10 oz., more preferably at least about 20 oz., and most preferably at least about 30 oz. Preferably, the bottle 110 is at most about 100 oz., more preferably at most about 80 oz., and most preferably at most about 70 oz. A growler embodiment is a 64 oz. bottle, and a small growler embodiment is a 32 oz. bottle. Although a generally cylindrical bottle 110 is shown in the figures, it is appreciated that the bottle 110 can have other suitable shapes and sizes.

FIG. 1 illustrates the bottle 110 having a body 112, shoulder 118, neck 128 (which includes an expansion chamber 136), and finish 132. Preferably, a transition is disposed where each adjacent portion of the bottle 110 meets. For example, the bottle 110 has a shoulder transition 126 from the body 112 to the shoulder 118, a neck transition 130 from the shoulder 118 to the neck 128, an expansion chamber transition 150 from the inner portion 134 of the neck 128 to expansion chamber 136, and an outer neck transition 151 from the expansion chamber 136 to the outer portion 135. In some configurations, the transition can have a smooth interior surface so that there is a smooth transition from each adjacent portion of the bottle. In other configurations, the interior surface of the transition can be sharp such that there is an abrupt or sharp transition from each adjacent portion of the bottle. In yet other configurations, some of the transitions can be sharp and others smooth.

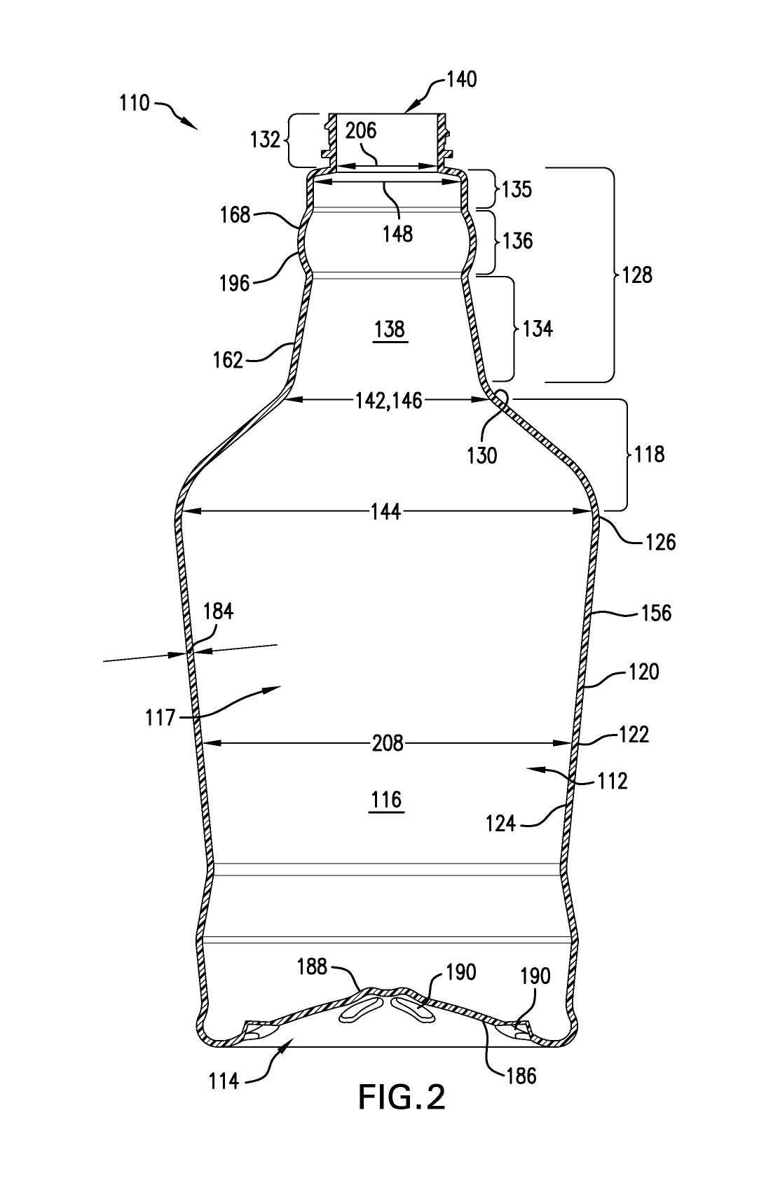

Referring to FIG. 2, a bottle wall 156 preferably forms the bottle 110 and defines a bottle interior space 117 to store a beverage. The bottle wall 156 includes a closed sidewall 120 and bottom 114 disposed at the inner or downward side of the bottle 110. The bottle wall 156 further includes the neck wall 162 that forms the neck 128 and the expansion chamber wall 168 that forms the expansion chamber 136. Preferably, as shown in FIG. 2, the bottle wall 156 has an interior surface 124, facing the bottle interior space 117, and an exterior surface 122 facing opposite the interior surface 124. Preferably, the bottle wall 156 is of a unitary material of general even thickness, typically subject to variances caused by blow molding, such that the exterior surface 122 of the bottle 110 defines generally the same shape as the interior shape of the bottle 110. Typically, the walls of the bottle have a thickness 184 of 0.008 to 0.15 inches. It is appreciated, however, that other suitable shapes and varying wall thicknesses can be used in certain embodiments. In some cases, the interior shape of the bottle 110 can have a different suitable shape from the exterior shape of the bottle 110, but a similar interior and exterior shape is preferred, especially in plastic bottles.

In the preferred embodiment, the bottle 110 includes a bottle body 112 having a generally cylindrical or slightly tapered shape. The taper shown tapers downward, expanding towards shoulder 118, with a different taper near the base 114 of the bottle 110.

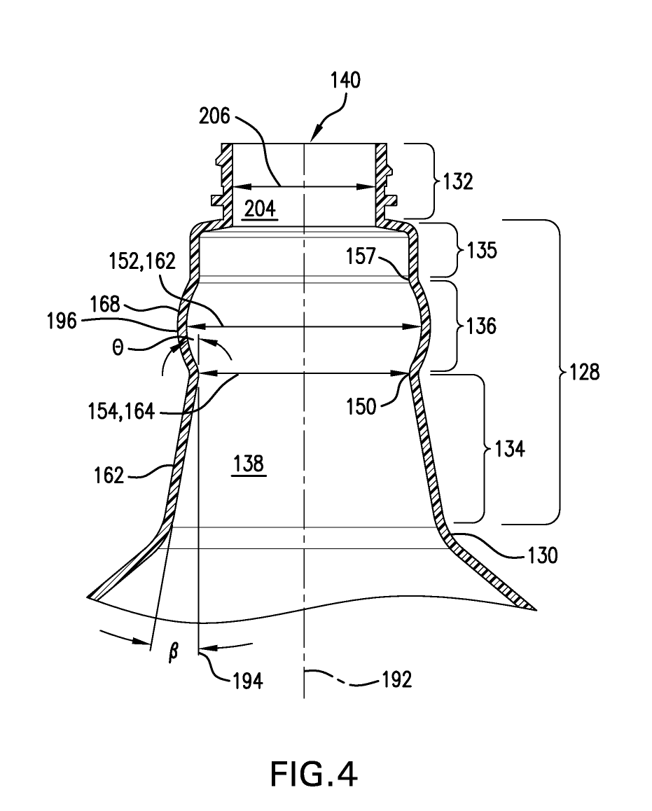

The bottle body 112 extends from the closed bottom wall 114 in an outer direction and transitions to the shoulder 118 of the bottle body 112. Referring to FIGS. 2 and 4, the interior surface of the bottle wall 156 has a concave curve with respect to the vertical axis 192 of the bottle 110 at the shoulder 118. Alternatively, the bottle 110 does not include a shoulder 118 and the bottle body 112 extends from the closed bottom 114 and connects to the neck 128.

The shoulder 118 is provided above the body 112 and connects to the neck 128. As illustrated in FIG. 1, in the preferred embodiment, the shoulder 118 tapers inward toward the neck 128 such that the cross-sectional area 144, which is preferably at the widest part of the shoulder 118, is greater than the cross-sectional area 142 of the widest portion of the neck 128. The interior radial cross-sectional area is perpendicular to the vertical axis 192 of the bottle 110. In some configurations, the widest part of the shoulder 118 can be at the interior shoulder transition zone 126. In some configurations, the widest part of the neck 128 can be at the interior of the neck transition zone 130.

The neck 128 extends from the shoulder 118 in an outer direction to the finish 132. The neck 128 preferably includes an inner neck portion 134, such as an elongated or lower portion, that is preferably elongated, an expansion chamber 136, and an outer neck portion 135, which in the embodiment of FIG. 2 are arranged in series from the shoulder to the outlet 140, such as a mouth. The inner neck portion 134 is preferably disposed toward the interior end of the bottle 110 and closed bottom 114, and the outer neck portion 135 is preferably disposed toward the outer end and outlet 140 of the bottle 110. Preferably, the bottle 110 has a single outlet 140 arranged at the outer end of the bottle 110 opposite the closed bottom wall 114 disposed at the inner end of the bottle 110. The outlet portion 135 of the neck 128 is positioned on the outlet side or outer of the neck 128 and extends from the expansion chamber 136 to the finish 132.

The bottle interior space 117 further includes a body interior space 116 defined by body of 112 of the bottle 110 and an interior channel 138 defined by the neck 128. The interior channel 138 is in fluid communication with the body interior space 116. The interior channel 138 extends through the inner portion 134, expansion chamber 136, and outer portion 135 to the outlet 140 of the bottle 110 for filling the interior space 116 and pouring the beverage therefrom.

The inner portion 134 of the neck 128 extends outward from the shoulder 118 and connects to the expansion chamber 136. Preferably, the neck 128 is tapered outwardly with respect to the vertical axis 192 as the inner portion 134 extends downward toward the shoulder 118. In the preferred embodiment, the tapered neck 128 has a generally frusto-conical shape. In this configuration, the interior radial cross-sectional area 146 of the inner portion 134 at its widest portion is greater than the interior radial cross-sectional area 148 of the outlet neck portion 135, which is at the outer most end of the neck. Preferably, the interior radial cross-sectional area 148 is at least about ⅓ of the interior radial cross-sectional area 146, more preferably, at least about ½ of the interior radial cross-sectional area 146, and most preferably at least about ⅔ of the interior radial cross-sectional area 146. Preferably, the interior radial cross-sectional area 148 is at most about 90% of the interior radial cross-sectional area 146, and more preferably, the interior radial cross-sectional area 148 is at most about ¾ of the interior radial cross-sectional area 146. Alternatively, the neck 128 is not tapered and the interior radial cross-sectional area 146 is substantially equal to the interior radial cross-sectional area 148. In some configurations, the widest portion of the inner portion 134 is at the neck transition zone 130.

Referring to FIG. 4, the neck 128 is tapered at an angle 13 with respect to the vertical axis 192. Preferably, angle 13 is about 10° to about 80°, more preferably about 15° to about 60°, and most preferably about 25°. It is noted that vertical line 194 is parallel to vertical axis 192, and is shown for reference purposes. Preferably, the neck 128 has an axial depth 174 that is less than the axial depth 176 of the bottle body 112. The axial depth 174 is preferably about ½ the axial depth 176 of the bottle body 112, and more preferably about ⅓ the axial depth 176 of the bottle body 112.

Preferably, the tapered neck 128 has a shallower taper than the tapered shoulder 118. Alternatively, the tapered shoulder 118 can have a shallower taper than the tapered neck 128.

The expansion chamber 136 extends from the outlet side of the inner portion 134, opposite the bottle body 112. The expansion chamber 136 includes an expansion chamber wall 168 that preferably extends in an axial direction with respect to the interior channel 138. The expansion chamber 136 in the preferred embodiment has generally the same cross-sectional shape as that of the inner portion 134 of the neck 128. In other configurations, the expansion chamber 136 can have a different cross-sectional shape than that of the inner portion 134 of the neck 128. For example, in some configurations, the expansion chamber 136 can have a generally rectangular, square, triangular, and other suitable cross-sectional shape.

In preferred embodiment, the expansion chamber wall 168 curves in an axial direction with respect to the vertical axis 192, and then subsequently curves back in an axial direction with respect to the vertical axis 192 toward the outer portion 135. Preferably, the expansion chamber 136 forms a bulge, as shown in FIG. 4, on the neck 128. The bulge can facilitate a user carrying the bottle. For example, when the bulge is also provided on the exterior of the bottle, it can provide a finger grip to facilitate gripping the bottle by the neck to prevent slipping through a user's fingers of hand. Alternatively, the expansion chamber wall 168 can have straight sides, such as to define a cylindrical portion with parallel sides or conical portion with tapered sides, or can have other suitable configurations.

Preferably, the interior radial cross-sectional area of the expansion chamber 136 increases (preferably gradually increases) in an outer direction from the expansion chamber transition zone 150 to a widest portion 196 of the expansion chamber, which in the embodiment shown is disposed about midway axially in the expansion chamber 136. The interior radial cross-sectional area of the expansion chamber 136 then decreases (preferably gradually decreases) in an axial direction from the widest portion 196 to the expansion chamber transition zone 150. In the preferred embodiment, the interior radial cross-sectional area of the expansion chamber 136 is greater than the interior radial cross-sectional area of the neck 128 adjacent the expansion chamber 136. In addition, the interior radial cross-sectional area 152 of the expansion chamber 136 at its widest portion 196 is greater than the interior radial cross-sectional area 154 of the adjacent portion of the neck 128, which is disposed at the inner portion 134 adjacent the expansion chamber 136. Preferably, the interior radial cross-sectional area 152 of the widest portion 196 of the expansion chamber 136 is at least about 10% larger than the interior radial cross-sectional area 154, more preferably at least about 30% larger, and more preferably at least about 50% larger. Preferably, the interior radial cross-sectional area 152 is at most about 70% larger than the interior radial cross-sectional area 154, and more preferably is at most about 75% larger, and can be at most about 130% larger. Preferably, the diameter 162 of the expansion chamber 136 at its widest portion 196 is larger than the diameter 164 of the adjacent portion of neck 128, which is the outer end of the inner neck portion 134. The diameter 162 is preferably at least about 5%, 10%, 20% larger than the diameter 164, and up to at most about 25%, 30%, or 50% larger than the diameter 164, although in some embodiments, other size ratios can be used. In an embodiment, the axial depth 178 of the portion of the expansion chamber that is larger in cross-section and diameter by these amounts than the adjacent portion or portions of the neck 128 is at least about 30%, 50%, or 75% of the depth 178 of the expansion chamber 136.

In the embodiment shown, the outer portion 134 has a similar sized interior radial cross-sectional area 148 as the interior radial cross-sectional area 154, and thus, the interior radial cross-sectional area 148 of the outer portion 134 has a similar relationship to the size of the interior radial cross-sectional area 152 of the widest portion 196 as the interior radial cross-sectional area 154 does. Alternative embodiments can have larger or smaller outer portions, and outer ends of the expansion chamber, compared to the outer end of the neck.

The interior radial cross-sectional area 146 of the tapered neck 128 at its widest portion can be equal to, less than, or greater than that of the interior radial cross-sectional area 152 of the widest portion 196 of the expansion chamber 136. In the embodiment shown in FIG. 2, the interior radial cross-sectional area 146 of the neck 128 at its widest portion is larger than that of the interior radial cross-sectional area 152 of the widest portion 196 of the expansion chamber 136.

With respect to the interior radial cross-sectional area 208 of the bottle body 112, preferably, the interior radial cross-sectional area 152 of the expansion chamber 136 at its widest portion 196 is at least about 10% of the interior radial cross-sectional area 208, and more preferably, at least about 20% of the interior radial cross-sectional area 208. Preferably, the interior radial cross-sectional area 152 is at most about ¾ of the interior radial cross-sectional area 208, more preferably at most about ½ of the interior radial cross-sectional area 208, and most preferably, at most about ⅓ of the interior radial cross-sectional area 208.

Preferably, the axial depth 178 of the expansion chamber 136 is about ⅓ to about ½ of the interior radial cross-sectional area 152 of the widest portion 196 of the expansion chamber 136, and more preferably about 40% of the interior radial cross-sectional area 152 of the widest portion 196. The axial depth 178 of the expansion chamber 136 is preferably at least about ¼ of the axial depth 174 of the neck 128, and more preferably at least about ⅓ the axial depth 174 of the neck 128. The axial depth 178 of the expansion chamber 136 is preferably at most about ¾ of the axial depth 174 of the neck 128, and more preferably at most about ½ of the axial depth 174 of the neck 128. With respect to the bottle body 112, the axial depth 178 of the expansion chamber 136 is preferably at least about 5% the axial depth 176 of the bottle body 112, and more preferably at least about 10% the axial depth 176 of the bottle body 112. The axial depth 178 of the expansion chamber 136 is preferably at most about ½ of the axial depth 176 of the bottle body 112, more preferably at most about ⅓ of the axial depth 176 of the bottle body 112, and most preferably at most about ¼ of the axial depth 176 of the bottle body 112.

The expansion chamber transition 150 preferably has an angle θ with respect to the vertical axis 192 that is at least about 10°, more preferably at least about 15°, and most preferably at least about 20°. The expansion chamber transition 150 preferably has an angle θ with respect to the vertical axis 192 that is at most about 90°, more preferably at most about 60°, and most preferably at most about 50°. Preferably, the outer neck transition 151 has an angle that is the same as the angle θ of the expansion chamber transition zone 150, although in alternative configurations, the outer neck transition 151 can have an angle that is different from the angle θ of the expansion chamber transition zone 150.

Preferably, the expansion chamber 136 is positioned between the outer portion 135 and the inner portion 134. The expansion chamber 136 is preferably positioned at an axial station 158 corresponding to the beverage fluid level 160 at the nominal capacity of the bottle 110. Preferably, the widest portion 196 is disposed at the axial station 158 of the nominal capacity. The nominal capacity of the bottle is the predetermined volume of the liquid that is designated for filling into the bottle prior to sale thereof. The nominal capacity varies depending on the size and type of the bottle, and sometimes also depending on the beverage or other fluid to be filled therein.

The nominal capacity can be the bottle standard capacity, which is the industry standard volume of liquid stored within a certain size and type of bottle, and which is set to leave a predetermined head space 200 within the bottle when filled. The predetermined head space is often set to control the decarbonation of carbonated beverages, such as soda and beer, and to prevent the bottle from exploding in certain circumstances, such as when shaken, during packaging, transportation, and shipping. For some types of beverages, the predetermined head space is set to reduce oxidation in beverage that are susceptible to it, such as beer.

The bottle 110 further comprises a finish 132. The interior channel 134 includes a finish channel 204 that extends from the outer portion 135 and extends through the finish 132 to the outlet 140 to allow for the bottle to be filled with a beverage and the beverage to be poured out of the bottle 110. Preferably, the finish channel 204 has an interior radial cross-sectional area 206 less than the interior radial cross-sectional area 148 of the interior channel 134 of the outer portion 135. Preferably, the interior radial cross-sectional area 206 is at least about ⅓ of the interior radial cross-sectional area 148 of the outer portion 135, more preferably at least about ½ of the interior radial cross-sectional area 148 of the outer portion 135, and most preferably at least about ⅔ of the interior radial cross-sectional area 148 of the outer portion 135. Preferably, the interior radial cross-sectional area 206 is at most about equal the interior radial cross-sectional area 148 of the outer portion 135.

In the preferred embodiment, the finish 132 includes threads 180 that form a continuous spiral configured to receive a screw cap 232 for closing off the interior channel 134. The finish 132 can further include a bead 182, such as a neck collar, for the cap to rest thereon. The bead 182 can also prevent liquid from leaking from the bottle 110. In some configurations, the bead 182 can also facilitate providing for an anti-tampering mechanism. Alternatively, a finish 132 without a bead 182 can be provided, such as for a cork or crown cap. In other configurations, other suitable methods of closing the bottle 110 can also be used.

The bottom 114 of the bottle 110 further comprises a seat 186. The seat 186 of the bottle 110 comprise of a concave surface 188 with respect to the bottle 100 and the concave surface 188 extends into the interior surface 116 of the bottle body 112. The pressure of the carbonated beverages can cause the bottom of a bottle to bulge outwardly which would render the bottle unstable when positioned upright. Having a concave surface 188 improves the stability of the bottle because the concave surface 188 mitigates bulging caused by the pressure of the carbonated beverages. Alternatively, such as for use with still liquids, the base can have a flat surface. The seat 186 also includes indentations 190 on the bottom side of the bottle 110 that facilitate aligning and orienting the bottle during filling and applying decorating lines, such as labels. Further, the indentations 190 can be configured as stiffening ribs to resist deformation of the bottom wall 114 due to the pressure from the carbonated beverage contained within the bottle 110.

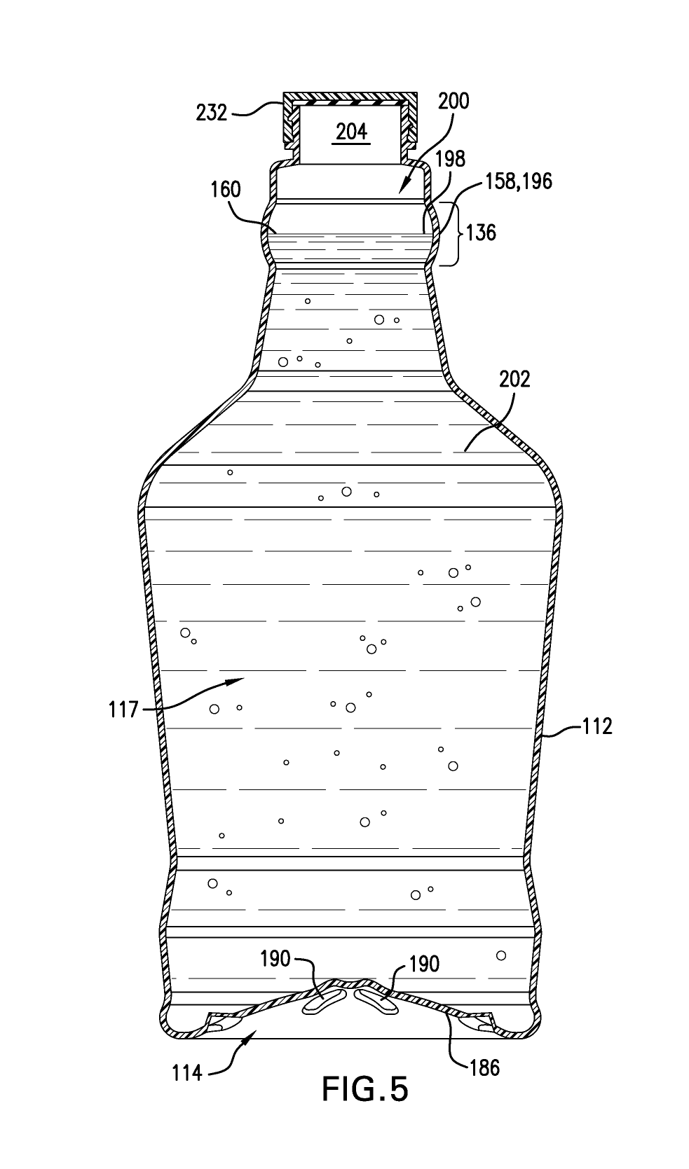

FIG. 5 illustrates the bottle 110 including beer 202 that is filled to the nominal capacity 198 at the axial station 158. In the embodiment shown in FIG. 5, the fluid level 160 is also at the nominal capacity 198. Preferably, the amount of head space 200 is about 2% to about 20% of the total capacity of the bottle 110, and more preferably about 3% to about 15% of the total capacity of the bottle 110. The standard amount of head space 200 often depends on the size of the bottle. For example, in smaller beer bottles, the head space 200 is preferably about 10% to 20% of the total capacity of the bottle, and in some configurations, about 12% of the total capacity of the bottle. In larger bottles, for example in a 64 oz. bottle, the preferred head space is about 3% to about 5% of the total capacity of the bottle. In some embodiments, the expansion chamber 136 can further include a fill line to indicate the nominal capacity of the bottle 110.

As the beverage is filled into the bottle 110, the vertical velocity of the beverage accelerates as it fills the shoulder 118 and further accelerates as it passes through the inner portion 134 of the neck 128 because of the tapered neck 128 configuration, even at a substantially constant flow rate, or volumetric fill rate. In traditional bottles, the narrow neck near the outlet makes it more difficult to accurately gage when to stop filling, such as when controlled manually from a beer tap. The expansion chamber 136 provides an increase in interior radial cross-sectional area compared to the adjacent portion of the neck 128, thus decelerating the vertical velocity of the fluid level 160 as it passes therethrough compared to the vertical velocity in the narrower, adjacent neck portion of the neck 128 for any maintained volume flow rate at which the beverage is filled into the bottle. Such deceleration improves a user's control over when to stop filling the bottle; i.e., when to close the valve or tap. Typically, a user would slow the volume fill rate as the fluid level 160 reaches the neck 128, and the expansion chamber 136 acts to automatically slow the fill rate be an additional amount, improving control over metering the bottle fill.

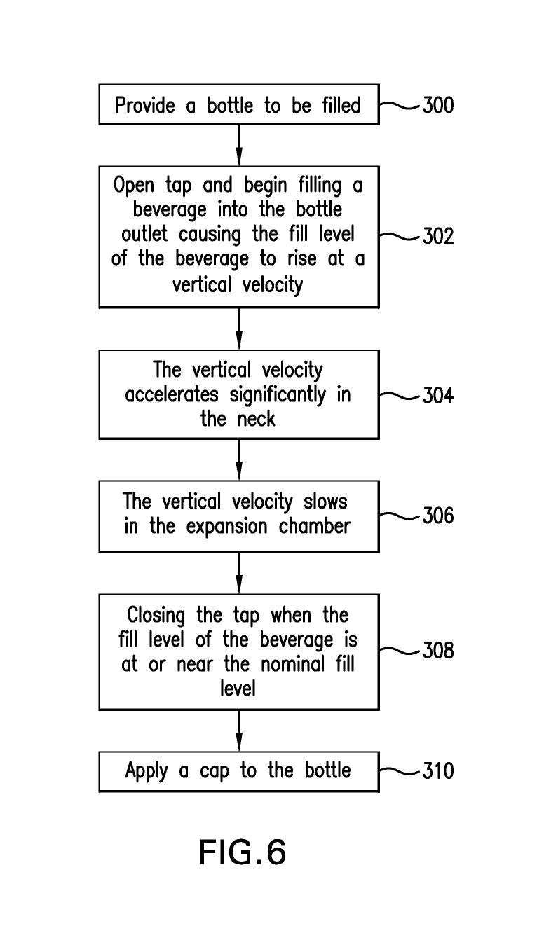

FIG. 6 illustrates an exemplary method of filling the bottle 110 described herein to the predetermined nominal capacity. A bottle 110 is first provided to be filled, such as at a microbrewery of craft beers (step 300). The tap is opened and begins filling a beverage into the outlet 140 of the bottle 110 causing the fluid level 160 of the beverage to rise at a vertical velocity (step 302). The vertical velocity accelerates significantly in the neck 128 (step 304). The vertical velocity slows in the expansion chamber 136 as the fill level 198 nears the nominal fill level 198 (step 306). The tap is closed when the fluid level 160 of the beverage is at or near the nominal capacity level 198 (step 308). A cap 232 is applied to the bottle 110 (step 310).

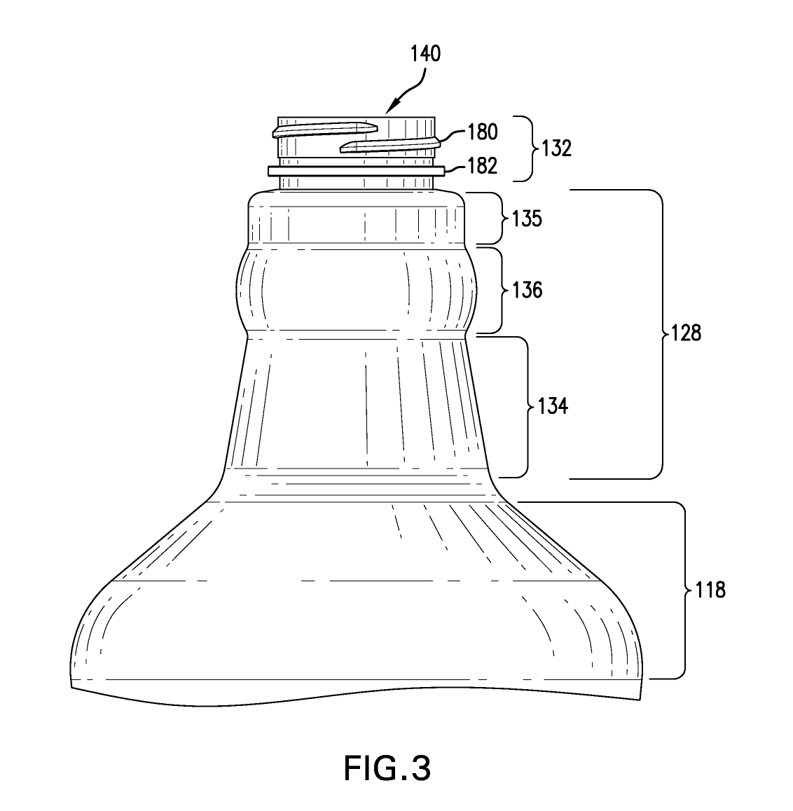

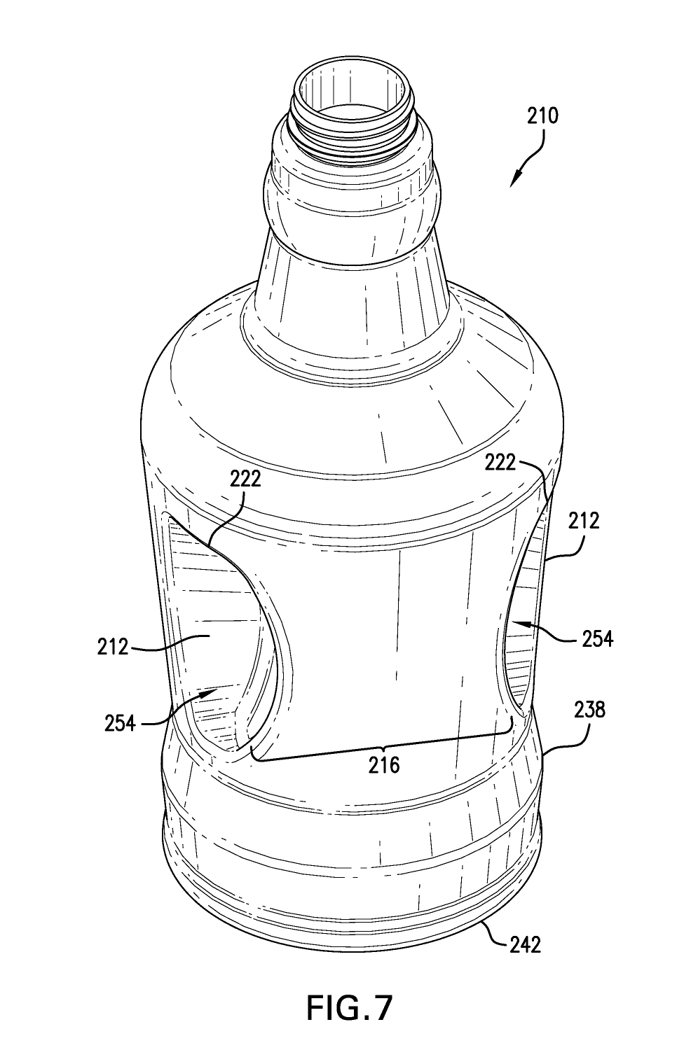

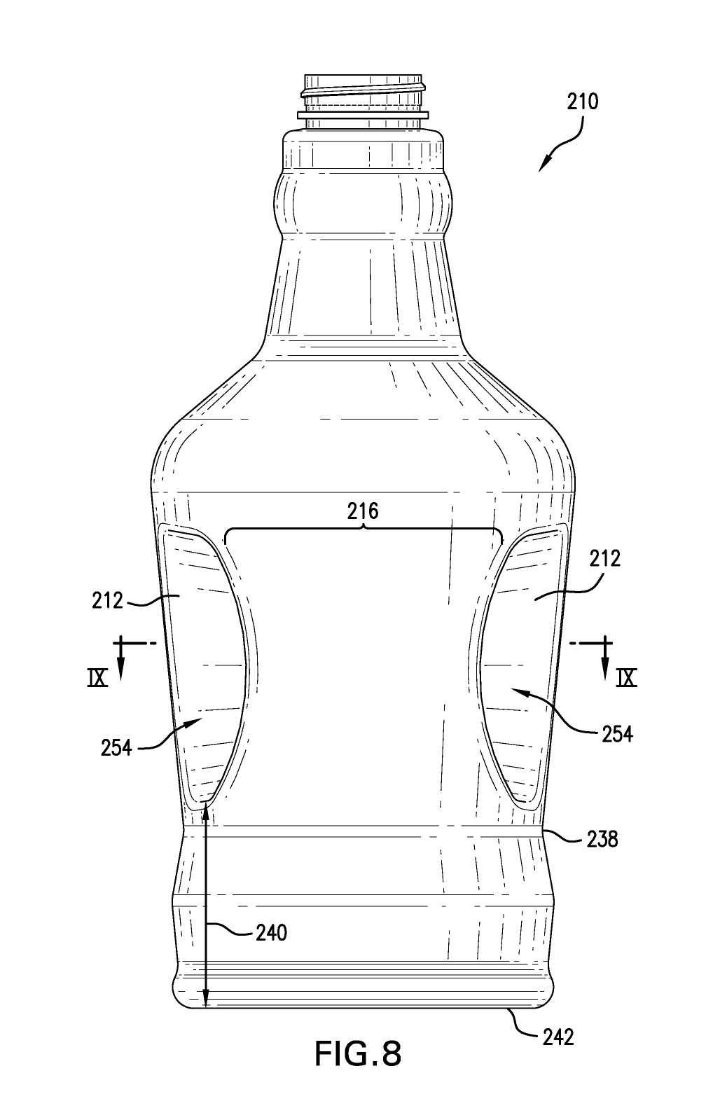

While the embodiment of FIGS. 1-5 has an uninterrupted sidewall at body 112 and preferably has no handle; alternative embodiments have handles, such as traditional glass or ceramic handles or a finger loop protruding from the side of the body. The embodiment of the bottle 210 of FIGS. 7-12, however, includes pinch grips 212 that allow a user to grasp the bottle much closer to the bottle's center of gravity, which can provide vastly increased control and stability when inclining the bottle for pouring, thus providing the user with significantly improved control over the pour to achieve a high quality foam head on poured beverages such as beer. Other features of bottle 210 can be as described above with respect to bottle 110.

While disclosed herein is a pair of pinch grips 212, it may be noted that that bottle 210 may include a single pinch grip 212 or 213, or another number of pinch grips in alternative embodiments. With a single pinch grip 212 or 213, a user may utilize the pinch grip 212 or 213 by pinching the pinch grip against the opposite side of bottle 210. As such, while two pinch grips 212 and 213 may be preferable, a single pinch grip may be usable.

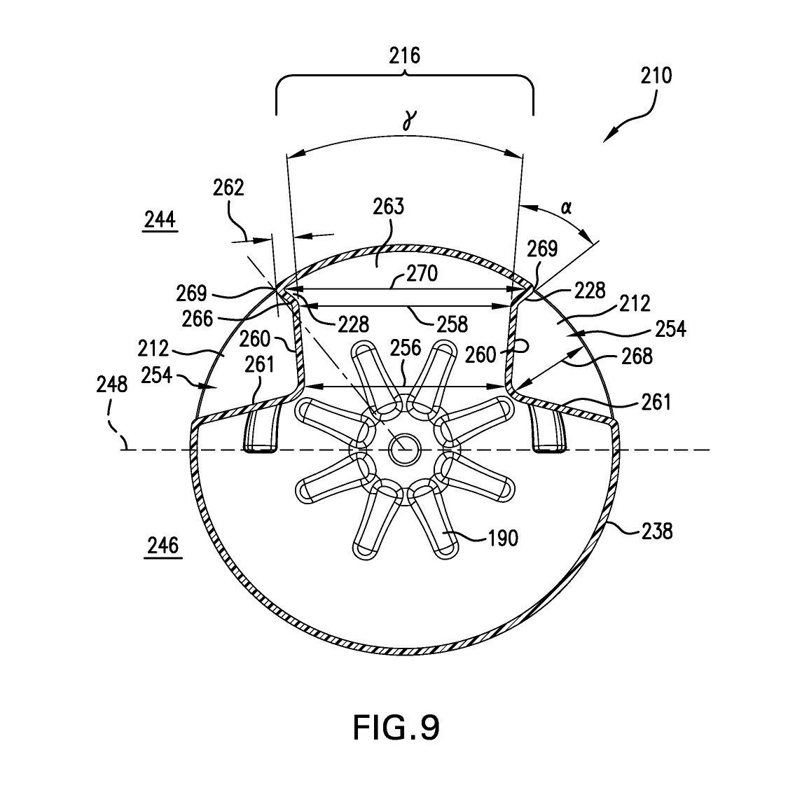

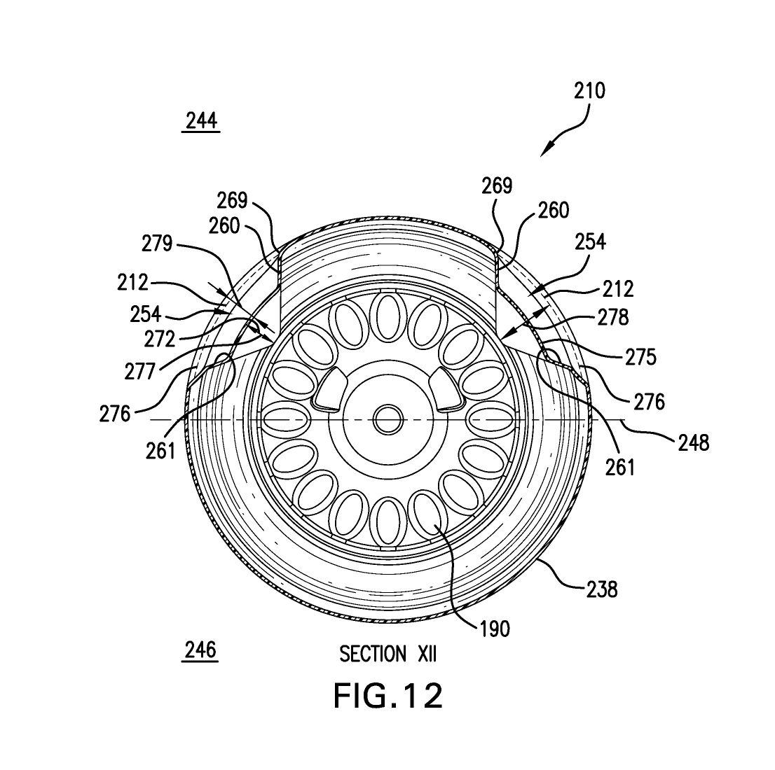

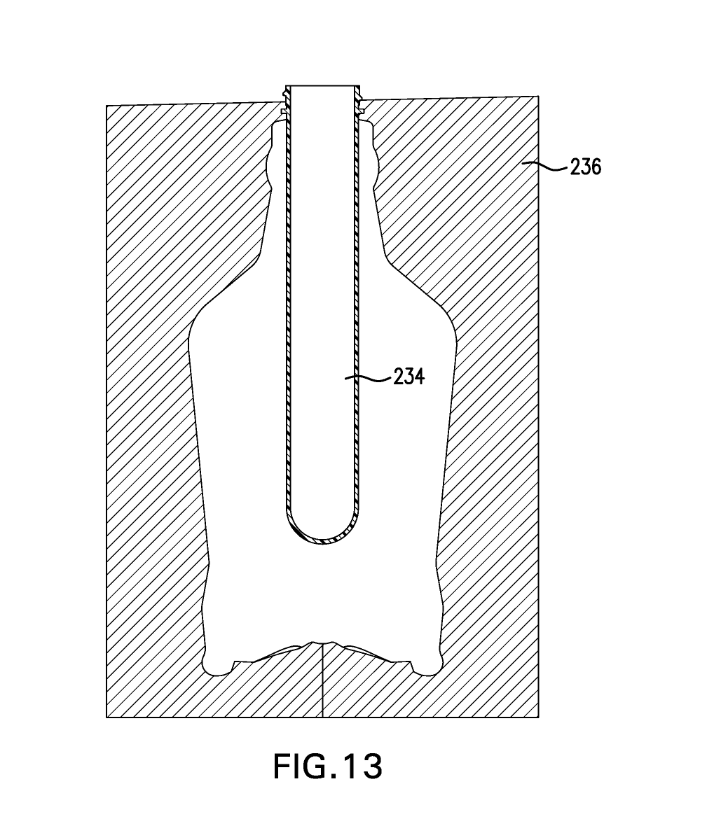

The pinch grips 212 of bottle 210 are preferably positioned along the side wall 214 of the body 238 of the bottle 210. As discussed in more detail below, the pinch grip 212 is indented into the side wall 214 of bottle 210. The indentation 254 is where the surface of the bottle 210 dips below the otherwise continuous circumferential body 238. Referring briefly to FIG. 12, the phantom projection 276 of the surface of the body 210 crosses the indentation 254. This is viewed at the height of cross section XII that cuts through the centerline of the gusset 274. As the surface varies depending on the shape of the body of the bottle 210 (e.g., conical in this embodiment, but alternatively cylindrical, rectangular, ovlate, square, etc.), the phantom projection 276 extends the cross-section of the surface of the body 210. In FIG. 12, with a conical body in the location of the indentation 254, the shape of the phantom surface and the extended perimeter line complete the otherwise missing piece of the shape of the body and in this example match the general shape of the body above and below the indentation. Since the cross-section of the body is circular, the phantom projection 276 in FIG. 12 is at a constant radius from the longitudinal axis of the bottle 210. The extended perimeter line or phantom projection line is a construct useful for highlighting the depth and shape of the pinch grip and related features relative the body 238 of the bottle 210. While the line is not shown per se in FIG. 9, the concept is none-the-less applicable to its disclosure.

The pinch grips 212 are at a distance 240 from the bottom 242 of the bottle 210. The distance 240 is measured from the bottom 242 to where the indentation of pinch grip 212 begins. Preferably, the distance 240 is about at least ⅕ of the height of the bottle 210 to about at most ½ of the height of the bottle 210.

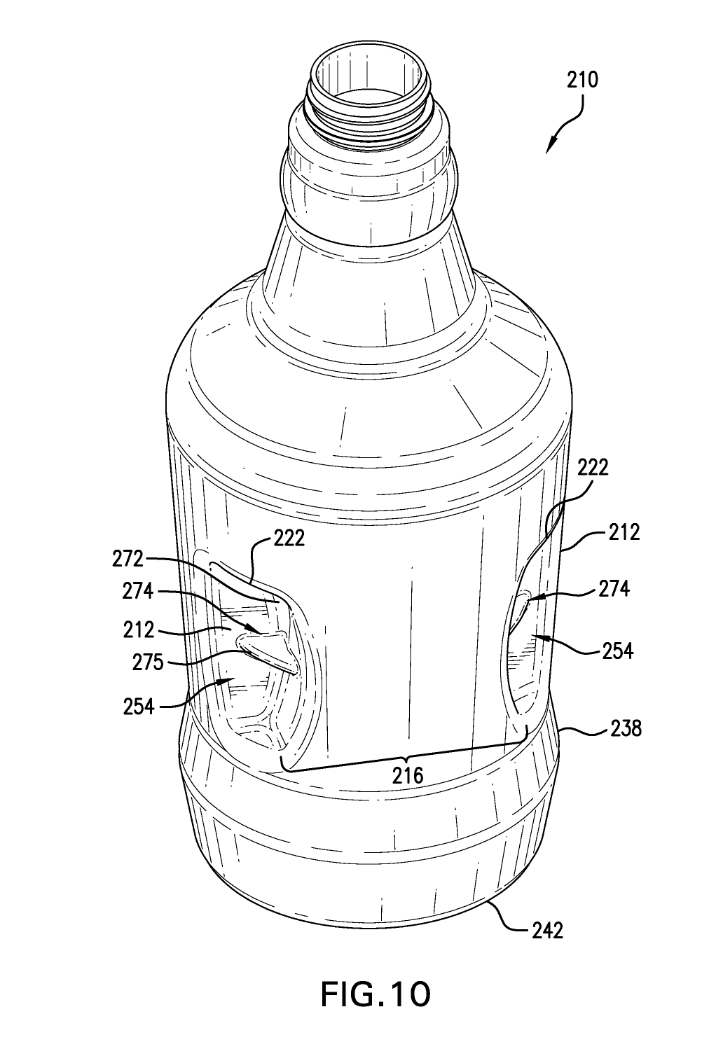

The indentation 254 may extend into the interior volume of bottle 210. The indentations 254 of pinch grip 212 may be specifically configured to resist popping out when the container is under pressure, such as when a carbonated beverage like beer is sealed within the container. Furthermore indentations 254 of pinch grip 212 may be configured to be held comfortably by human fingers. The indentations 254 may have a constant depth or the indentations 254 may have various depths. However, at its deepest, at the radial bottom of the indentation, the depth of the indentation, it may be 10%-40% of the body's radius at the axial height of the indentation 254. More preferably, the indentation may be 30%-40% of the radius of the body. The indentation may be one-third of the radius of the body. In one embodiment, the volume of the pinch grips 212 may be about 41 cm³. In one embodiment, the area of the bottle 210 that is indented to form the pinch grips may occupy 65 cm². Other dimensions and locations of pinch grips may be used, in any of the embodiments described herein, and the dimensions and locations of the pinch grips and other bottle features as described for the previous embodiments can be used in the bottle shown in FIGS. 10-12.

Traditional beer growlers include a metal handle for pouring the beer out of the growler. Traditional beer growlers, however, can be difficult to pour properly due to their size and filled weight. Compared to these traditional handles, providing the disclosed pinch grips 212 provide for finer control over the pouring and metering of the beverage into the glass for consumption because it allows for a user to grip the bottle 210 closer to its center of gravity. In embodiments in which the bottle 210 contains beer, for which the quality and amount of the foam formation are particularly susceptible to the manner of pouring, the pinch grips 212 can provide finer control with the amount of foam formed when pouring the beer out, for example, into a person's glass. Other embodiments, including in embodiments containing liquids other than beer, can use different locations for the pinch grips.

The two pinch grips 212 are comprised of indentations 254 positioned on the same side (preferably the back side 244) of the bottle 210. For example, as shown in FIG. 9 or 12, the pinch grips 212 are preferably positioned on the same half of the bottle 210. It is noted that line 248 denotes the split between the front side 246 and back side 244 of the bottle 210 for illustrative purposes only. The pinch grips 212 may also extend across line 248 such that the pinch grips 212 are not on the same side of the bottle.

A palm area 216 of the exterior surface of the body 238, which faces the user's palm when gripping the bottle 210, is positioned between the two pinch grips 212. The palm area 216 is preferably sized such that a person can hold the bottle 210 in one hand with the person's thumb in one pinch grip 212 and the remaining figures in the other pinch grip 212.

The pinch grips 212 extend radially inward with respect to the outer surface of the body 238, forming pinch grip indentations 254. The pinch grip indentations 254 are defined by pinch walls 260 and forward walls 261. The pinch walls 260 and forward walls 261 form the pinch grip indentation by dipping below the body 238 and connecting at the indentation base 272. The indentation base may be flat, concave, convex, merely a radius connection between the pinch walls 260 and forward walls 261, or the immediate intersection of pinch walls 260 and forward walls 261. The pinch walls 260 and forward walls 261 may be flat, concave or even convex. The pinch grips 212 may have a hemispherical shape which may poorly define a forward wall 261 and a pinch wall 260. However, the pinch wall 260 of each pinch grip indentation 254 is positioned circumferentially closer to the pinch wall 260 of the other pinch grip indentation 254 than the circumferential spacing between the forward walls 261. Or in the instant where the walls are poorly defined because of a hemispherical shape (or similar shape that does not clearly define separate walls) the portion of the shape that is closer to the other pinch grip may be considered the pinch wall 260 and the portion of the shape that is farther from the other pinch grip may be considered the forward wall 261. The pinch walls 260 of each pinch grip indentation 254 are preferably non-parallel to each other, although in some embodiments can be generally parallel, and are oriented at an angle γ (as shown in FIG. 9 but similarly applicable to FIG. 12) with respect to each other of about at least about 2° or 5°, and up to about 20° or 30°, with the pinch walls 260 angled towards each other towards the depth of the pinch grip indentations 254. In one embodiment, angle γ is around 10°, and a grip portion 263 of the body 238 between the pinch walls 260 tapering toward the maximum depth 268. The pinch wall 260 of the pinch grip indentations 254 are thus spaced at a distance 256 from each other near the maximum depth 268 closer than they are near the finger opening into the pinch grips 212, at a shallower side of the pinch grip indentations 254 (distance 258). Preferably, the distance 256 of the deeper side is about at least 5% to at most about 25% less than the distance 258 at the shallower portion of the pinch grip indentations 254. The pinch grips may have a circumferential width between one another of 15-25% of the circumference of the bottle at the pinch grip.

As shown in FIGS. 7-9, the pinch grips 210 may further include a raised lip 228 disposed along the intersection of the edge 222 of the pinch grip indentations 254 and the outer surface of body 238. As shown in FIG. 9, the lip 228 is disposed where the circular cross-section of the body 238 is interrupted by the pinch grip indentation 254. The raised lip 228 also stands proud against the pinch grip wall 260. The lip 228 facilitates gripping of the pinch grips 212 by a user by preventing the bottle 110 from slipping out of a person's hand and providing better control of the bottle 110 during pouring. Preferably, the lip 228 extends from the pinch grip wall 260 to a height 262 that is about at least about 5% or 10% of the distance 258 between the shallower sides of the pinch grips indentations 254, typically to about 15% or 20%. Preferably, the distance 270 between the peaks 269 of each lip portion 228 is larger than the distance 258 between the shallower sides of the pinch grip indentations 254. In the preferred embodiment, the distance 270 is about at least 5%, 10%, or 15% larger than the distance 258 between the shallower portion and at most about 20% or 25% larger. Preferably, the lip 228 extends from the inner pinch grip wall at a suitable angle α, such as between about 20° to 90°. It is appreciated that in some embodiments of the pinch grips 210, the pinch grip edge 222 does not have the lip portion 228. The depth and position of maximum depth of the pinch grips 212 position the user's fingers radially and axially near the center of gravity during gripping and handling to improve fine control of the bottle 110 while pouring out the beverage, enabling more consistent and easier formation of a high quality beer foam head.

Because bottle 210 may be used with carbonated liquids (e.g. beer, soda or any similar liquid), high pressures in the bottling process or pressures from the carbonation separating from the liquid may cause the bottle to bulge out. Generally the cylindrical (or conical) shape of the bottle 210 is sufficient to handle the pressure. However, non-cylindrical features of the bottle such as the pinch grips may not handle the pressure as well. This is the issue with other bottles on the market, many of which that have non-cylindrical features do not handle liquids that can create pressures such as carbonated liquids. However by sizing the pinch grips, e.g. the size relationships discussed above, and/or by adding a gusset in a suitable configuration the pinch grips can be utilized on a pressurized bottle without the pinch grips popping out.

As shown in FIGS. 10-12, the pinch grip indentations 254 may further include gussets 274. Gussets 274 may extend generally circumferentially between the pinch wall 260 and the forward wall 261. As Gussets 274 extend generally circumferentially between the pinch wall 260 and the forward wall 261, they may follow the profile of the body 238. For example, gussets 274 may follow an ark or be convex. Gussets 274 may alternatively form a concave shape between the pinch wall 260 and the forward wall 261.

As shown in FIG. 12 the lowest point of the indentations 254 relative to the phantom projection 276 is the indentations base 272. This distance, measured at its deepest, at the radial bottom of the indentation, the depth of the indentation, is shown as radially extending measurement 278. Gussets 274 may be elevated above the indentations base 272 up to gusset ridges 275. The gussets 274 may extend to the deepest part of indentations base 272. Gussets 274 extend radially from the indentation base 272 to the gusset ridges 275 indicated as the radially extending measurement 277. At least a portion of gussets 274 do not extend to the deepest radial bottom of the indentation, or the full depth of the indentation. Stated another way, at least a portion of gussets 274 do not extend from the indentation depth 274 up to or proud of the phantom projection 276. As such the gussets 274 remain below the phantom projection 276 by a radially extending distance 279. The gussets 274 may extend radially up to or less than about 80% of the depth indentations 254 (as measured as a ratio of the indentation base 272 to the phantom projection 276 as shown by radially extending measurement 278 compared to the indentation base 272 to the gusset ridges 275 as shown by radially extending measurement 277.) The gussets 274 may extend radially up to or less than about 75%, 50%, or 30% of the depth of indentations 254 or the deepest radial bottom of the indentation (as similarly measured.) The gussets 274 may extend radially more than 20% of the depth of indentations 254 or the deepest radial bottom of the indentation. The gussets 274 may extend radially from about 20% to about 80 of the depth of indentations 254 or the deepest radial bottom of the indentation. The gussets 274 may extend radially from about 30% to about 70 of the depth of indentations 254 or the deepest radial bottom of the indentation. The gussets 274 may extend radially from about 40% to about 60 of the depth of indentations 254 or the deepest radial bottom of the indentation. Preferably the gussets 274 may extend radially from about 50% of the depth of indentations 254 or the deepest radial bottom of the indentation. The smaller the gusset 274 is relative to the pinch grip, the less space from the pinch grip indentation it takes up, and the more room a user's fingers are left utilize the pinch grip for gripping.

The area of the pinch grip indentations can be made smaller than typical pinch grips in bottles made for still liquids, as larger indentations are less resistant to gas pressure buildup from carbonation. The low radial height of the gussets has been found to allow the size of the pinch grips to be increased, by helping to resist the interior pressures, while allowing more space to remain for a user's fingers in gripping the bottle. Taller gussets take up more space that could otherwise be used for fingers, and the shorter, disclosed pinch gussets have been found to sufficiently resist internal pressures and keep the pinch grips from popping out.

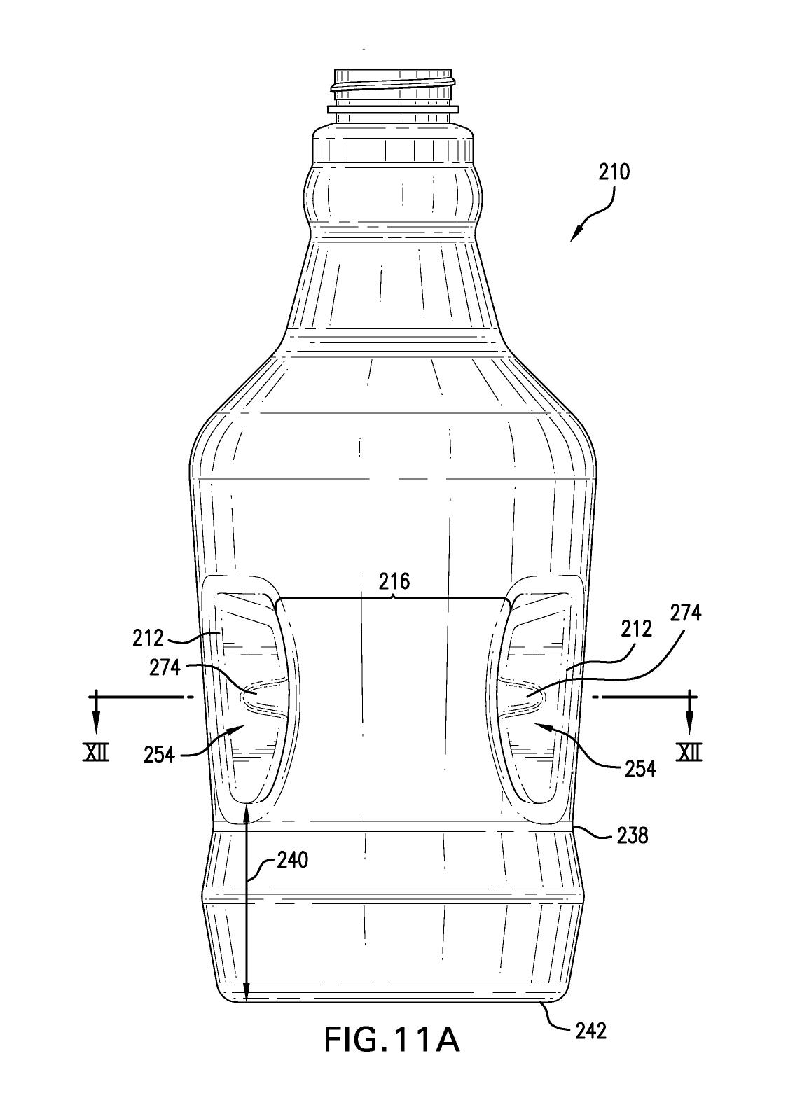

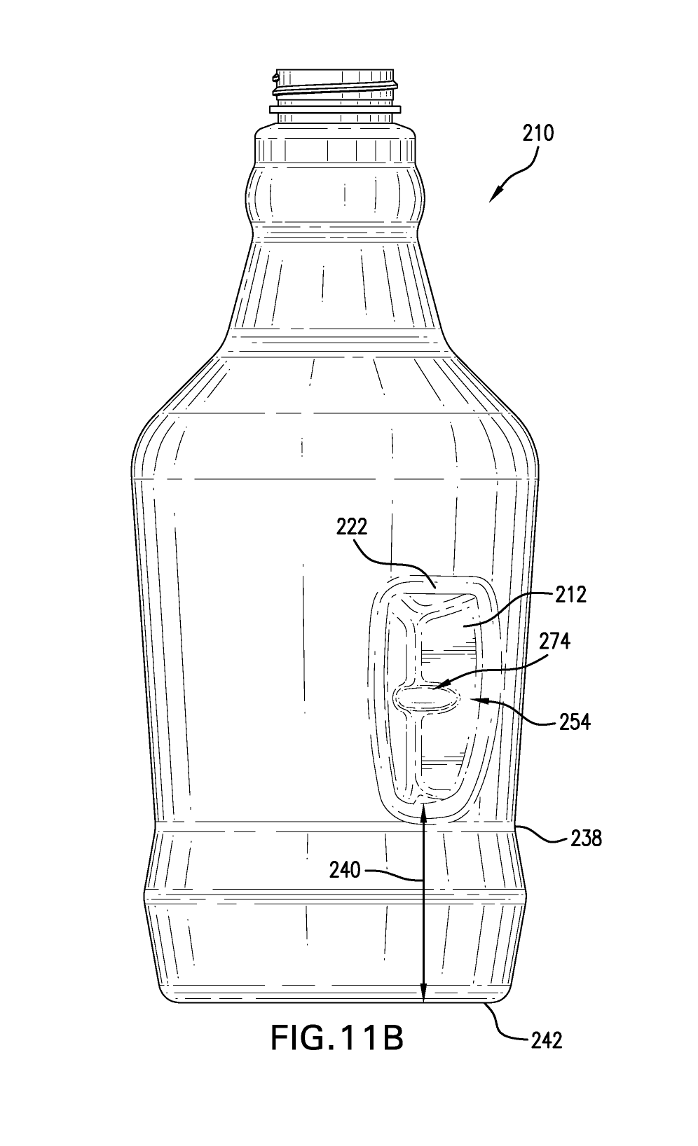

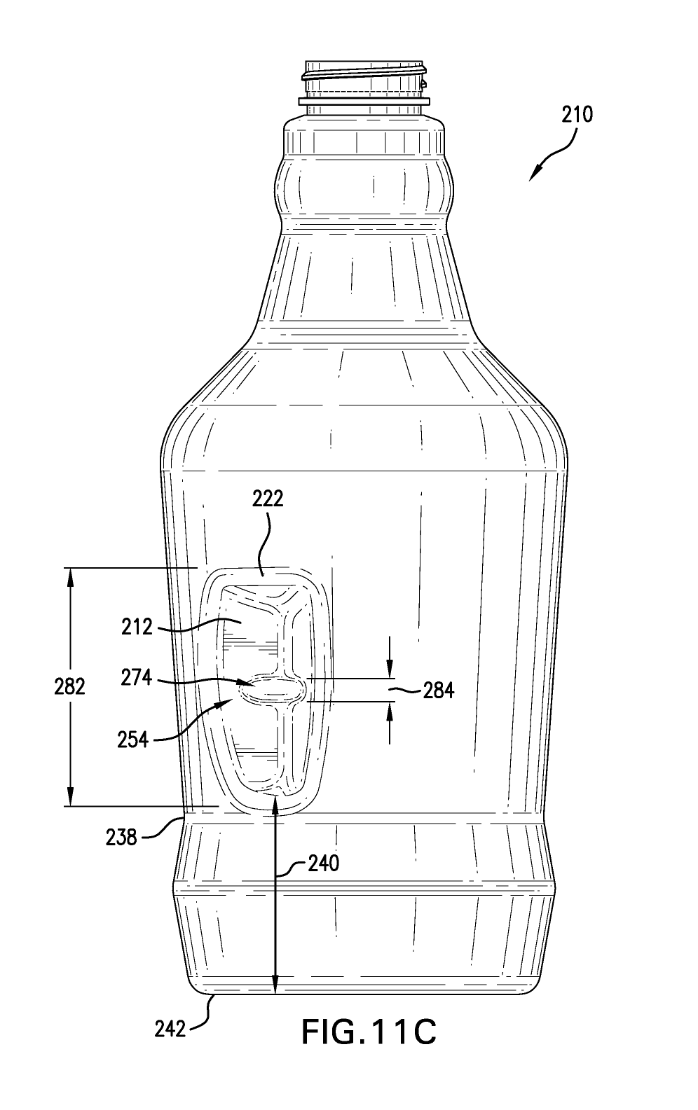

The axial height of gussets 274 (indicated by height 284 in FIG. 11C) may be equal to or greater than 10% of the axial height of the pinch grip (indicated by height 282 in FIG. 11C.) The axial height of gussets 274 may be equal to or less than 25% of the axial height of the pinch grip. In one embodiment the axial height 282 of the pinch grip may by about 2-3 inches in one embodiment, and about 2.5 inches in one example, and the axial height of the gussets 274 may be about 0.1 to 0.5 inches, and about 0.3 inches in that example. With greater axial height of gusset as compared to the axial height of the pinch grip the gusset maintains sufficient strength to cause the pinch grip to withstand internal pressures while minimizing the gussets size in the radial direction and intrusion into the space available for fingers.

The gusset is typically located about 20-45% up the height of the bottle as measured from the base of the body. Preferably, the gusset may be located about 30-35% up the height of the bottle as measured from the base of the body. The gusset may be located about the center of the pinch grip. In one embodiment, the gussets 274 may be located about 3 to 4 inches from the base of the bottle 210.

An alternative embodiment of a bottle can be provided including the pinch grips as described in FIGS. 7-9 without an expansion chamber and/or with different features than described with respect to the embodiment of FIG. 1. The gusset features as described in FIGS. 10-12 may also be utilized with or without the lip features of FIGS. 7-9 and/or the expansion chamber or other features as discussed herein.

The bottle may be formed in any suitable method known in the art and from any suitable material. In certain embodiments, the threads of the threaded neck may be formed via injection-molding, while most or all of the rest of the bottle may be formed via blow-molding. The blow molding process begins with melting down the plastic and forming it into a preform 234. The preform 234 is a tube-like piece of plastic with a hole in one end through which compressed air can pass. The preform 234 is then clamped into a mold 236 and air is pumped into it. The air pressure then pushes the plastic out to match the mold 236. Once the plastic has cooled and hardened the mold opens up and the part is ejected.

FIG. 10 illustrates preform 234 that has been pre-formed by injection molding and is placed into and blow molded in a blow mold 236. Typically, the finish 132, includes the threads 180 and other features that associate with a cap 232. Such method of making the bottle can provide improved control over wall thickness after the blow molding step, such as at the expansion chamber 136, which can be desirable in embodiments in which the inner contours of the expansion chamber are desired to be tightly controlled. Other suitable methods of making the bottle can alternatively be used, such as completely injection molding the bottle.

Any and all references specifically identified in the specification of the present application are expressly incorporated herein in their entirety by reference thereto. The term “about” and “approximately,” as used herein, should generally be understood to refer to both the corresponding number and a range of numbers. Moreover, all numerical ranges herein should be understood to include each whole integer within the range.

While illustrative embodiments of the invention are disclosed herein, it will be appreciated that numerous modifications and other embodiments may be devised by those skilled in the art. For example, the features for the various embodiments can be used in other embodiments. Therefore, it will be understood that the appended claims are intended to cover all such modifications and embodiments that come within the spirit and scope of the present invention.

1. A bottle, comprising:
a bottle body defining an interior space configured for storing a beverage; and
a neck including:
an inner portion extending from the body, and
an expansion chamber extending from the inner portion opposite the body, the neck defining an interior channel in fluid communication with the interior space and extending through the inner portion and expansion chamber to an outlet of the bottle for filling the interior space and pouring the beverage therefrom;
wherein the channel in the inner portion has a first cross-sectional area leading into the expansion chamber, and the channel in the expansion chamber has a second cross-sectional area that is significantly larger than the first cross-sectional area to significantly slow the rise in beverage level in the expansion chamber as the bottle is filled

2. The bottle of claim 1, wherein the second cross-sectional area is at least about 10% larger than the first cross-sectional area.

3. The bottle of claim 2, wherein the second cross-sectional area is between about 10% to about 70% larger than the first cross-sectional area.

4. The bottle of claim 1, wherein the expansion chamber has a similar cross-sectional shape as the inner portion.

5. The bottle of claim 1, wherein the inner portion has a substantially cylindrical portion adjacent the expansion chamber and having the first cross-sectional area.

6. The bottle of claim 1, wherein the inner portion has a tapered portion adjacent the expansion chamber that narrows towards the expansion chamber.

7. The bottle of claim 6, wherein the first cross-section is disposed at a transition between the inner portion and the expansion chamber.

8. The bottle of claim 1, wherein the expansion chamber comprises a wall that is curved in an axial direction with respect to the channel.

9. The bottle of claim 1, wherein the neck portion is made of a wall having interior and exterior surfaces, the wall having a generally even thickness such that the interior and exterior surfaces of the expansion chamber have similar shapes.

10. The bottle of claim 9, wherein the exterior of the expansion chamber defines a finger grip bulge to facilitate carrying the beverage bottle.

11.-14. (canceled)

15. The bottle of claim 1, wherein the beverage bottle contains beer.

16. The bottle of claim 1, wherein the expansion chamber is disposed axially along the neck at a capacity level corresponding to the nominal capacity of the bottle to slow the vertical speed of rising beverage during filling as the beverage reaches said capacity level.

17. The bottle of claim 16, wherein the greatest cross-sectional area of the expansion chamber is disposed substantially at said capacity level.

18. The bottle of claim 16, wherein the bottle is a growler.

19. The bottle of claim 1, wherein the body includes a shoulder that is highly tapered towards the inner portion of the neck.

20.-22. (canceled)

23. A method of filling a bottle to a predetermined nominal capacity, comprising:
providing a bottle according to claim 1;
filling the beverage into the neck, such that the beverage level has a vertical velocity corresponding to the volume filled into the bottle, wherein the vertical velocity slows significantly at the expansion chamber to facilitate stopping the filling at the nominal capacity.

24. The method of claim 23, further comprising stopping the filling when the beverage level is within the expansion chamber or slightly above.

25. The method of claim 24, wherein the beverage is beer.

26. (canceled)

27. A bottle, comprising a bottle wall that includes:
a body having a base and an outer circumferential wall which defines an interior space configured for storing a liquid;
a pinch grip recessed into the body to facilitate gripping the bottle, the pinch grip including an indentation recessed into the body, the indentation comprising a forward wall and a pinch wall, the forward wall and the pinch wall extending inwardly from the outer circumferential wall to the indentation base; and
a gusset extending generally circumferentially across the indentation between the forward wall and pinch wall with at least a portion of the gusset extending radially from the base to about 20-80% of the depth of the indentation.

28.-39. (canceled)

40. A drink container, comprising:
a plastic bottle comprising:
a body defining an internal space,
opposing pinch grips extending radially inwardly forming a cavities on a circumferential side wall of the body, wherein the pinch grips facilitate gripping the bottle near a center of gravity thereof, and
a gusset traversing each of the cavities of the pinch grips with the gusset disposed with in the cavity and radially below the surface of the circumferential side wall of the body;
a carbonated beverage contained in the body which exerts an outward circumferential pressure; and
a closure sealing the internal space to contain gaseous pressure of the carbonated beverage;
wherein the pinch grips connect opposing walls of the pinch grip to resist popping out due to the outward pressure from the carbonated beverage.

41.-43. (canceled)
